(19) United States
(12) Patent Application Publication
(10) Pub. No.: US 2007/0022051 A1
(43) Pub. Date: Jan. 25, 2007

(54) System and method for multi-application payment processing

(75) Inventors: John Regan, Boxford, MA (US); Michael Irvine, Dunstable (GB); Mark Connolly, Westford, MA (US); Gerard Kiley, Lynnfield, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Parcxmart Technologies, Inc., Hampton Falls, NH (US)

(21) Appl. No.: 11/436,406

(22) Filed: May 18, 2006

Related U.S. Application Data
(60) Provisional application No. 60/682,519, filed on May 18, 2005.

(51) Int. Cl. G06Q 40/00; G06Q 99/00; H04L 9/00; H04K 1/00

(52) U.S. Cl. 705/40; 705/64

(57) ABSTRACT

A multi-application payment system and method operates in a hybrid closed/open manner. The multi-application payment system and method features a smart card wherein funds are added to the card at point of sale (POS) locations. The card keeps track of the available balance and is used to purchase goods/services at any POS location. During a transaction, the POS location verifies the amount of funds available and then debits the funds available on the card. Transactions between the card and the POS location are preformed in a substantially closed manner. The POS location then transfers data about the transaction (preferably in a batch manner) to a central processing system. The central processing system processes the data in a generally open manner to move funds to the appropriate account, preferably using the Federal ACH interface.

### CROSS-REFERENCE TO RELATED APPLICATIONS

This application claims the benefit of U.S. Provisional Application Ser. No. 60/682,519, filed May 18, 2005, which is fully incorporated herein by reference.

### TECHNICAL FIELD

The present invention relates to systems and method for electronic payment and more particularly, relates to smart cards that use merchant Point-of-Sale terminals to load value onto the smart cards which can then be used off-line to purchase time for parking at meters and garages.

### BACKGROUND INFORMATION

Parking meters are well known and are used to generate revenue and control parking in an area. In a traditional parking meter, a user inserts cash (typically coins or bills) into the parking meter to purchase a desired amount of time. While generally effective, one disadvantage of the traditional parking meter is that it requires a user to have cash on hand to pay for the parking.

Parking cards have been developed in an attempt to overcome some of the disadvantages of the traditional, cash-based parking payment systems. The known card-based parking payment systems generally operate in a closed payment system (closed system). In the closed systems, the card may only be used to purchase parking in a limited marketplace and is controlled by the parking operator. Parking transactions are processed entirely within the network and the funds never leave the network. Value is added to the card only at locations under the control of the parking operator.

The closed system has the advantages that risk is low, due to the restricted nature of the system, and that the processing requirements are fairly low. Accordingly, a closed loop payment system can be fairly easily implemented. However, a major disadvantage of the closed systems is that value loads and purchases can only be made at locations that are controlled by the parking operator. Within the parking industry, these difficulties have generally limited closed loop parking systems to a handful of locations within a single city and have prevented a system from being developed wherein an individual can make purchases national wide.

In contrast to closed systems, open payment systems (open systems) are run not by the parking operator, but by a payment company. Purchases and value loads can be made at any participating merchant and funds flow between the payment system operator and the participating merchants. In an open system, each transaction must be processed individually and the funds apportioned accordingly. One benefit of an open loop system is that each merchant/POS uses the same system, therefore a single card can be used to make purchases anywhere.

Traditional open systems are run by payment organizations backed or owned by large financial institutions (for example MasterCard® or Visa®). These systems largely operate (at least in the United States) using magnetic stripe technology. Because of the inherent security weaknesses with this technology in regard to card authentication, most of these transactions are handled in an on-line real-time manner.

However, traditional open systems are difficult to integrate into certain classes of payment devices. Because each and every transaction is individually communicated to the central processing system, the known open systems require a significant amount of power and require the POS location to be able to continuously communicate with central processing system. As a result, the known open systems are too expensive to integrate into off-line parking meters and the like.

Accordingly, what is needed is a payment system that can be easily integrated into both the off-line parking meters and the potentially on-line merchants. The payment system should preferably operate in a manner that allows transactions to be collected and processed from off-line devices on an extended periodic basis and from on-line devices on a more regular (batch) basis while the individual transactions are still accepted in an off-line manner. Once the transactions have been collected and processed by the payment system operator (as part of a multi-party closed system), the funds are preferably moved between the operator and the participating merchants and/or cities using the current open payment system (Federal ACH). Accordingly, what is needed is an effective and efficient means of processing transactions from all potential acceptance locations using a hybrid open/closed payment system.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features a multi-application payment method. The method includes performing a first transaction between a card and a point of sale (POS) location at the POS location in a closed system including determining an available balance on the card and comparing an amount of the first transaction to the available balance. If the available balance is less than the first transaction amount, then the first transaction is terminated. If the available balance is at least equal to the first transaction amount, then the first transaction amount is deducted from the available balance on the card. Data regarding the first transaction is then stored at the POS location and transmitted from the POS location to a central processing system. The data is then processed at the central processing system in an open system.

In the preferred embodiment, the data is transmitted from the POS location in either a batch manner or periodically. The data is preferably collected from the POS location onto a data collection device using a wireless connection and then transmitted from the data collection device to the central processing system. The central processing system preferably identifies an account corresponding to the POS location from the data and transfers the funds from a central funds pool to the account, preferably using the Federal Automated Clearing House (ACH) Network.

Value may be added to the card at the POS location. After adding value to the card, the new available balance is calculated and stored on the card. The value is preferably added to the card in a closed manner.

According to another embodiment, the present invention features a multi-application payment method comprising the acts of performing a first transaction between a card and a point of sale (POS) location wherein the first transaction is completed between the card and the POS location in a generally closed manner. Data relevant to the first transaction is transmitted from the POS location to a central processing system. The central processing system then routs funds between a central pool of funds and at least one user account in a generally open loop manner.

According to yet another embodiment, the present invention features a multi-application payment method wherein a first transaction is completed between a card and a point of sale (POS) location at the POS location in a closed system. Data including card account information and an available balance is received from the card and the transaction purchase amount is compared to the available balance. If the available balance is less than the transaction amount, then the first transaction is terminated. If the available balance is at least equal to the first transaction amount, then the transaction amount is deducted from the available balance on the card and the available balance is updated on the card. Financial data regarding the transaction is stored at the POS location and transmitted from the POS location to a transaction collection device in a batch manner. The financial data is then transmitted from the transaction collection device to a central processing system where it is processed in an open system. An account corresponding to the POS location is identified based on the data and funds are routed from a central funds pool to the account using the Federal Automated Clearing House (ACH) Network.

According to yet a further embodiment, the present invention features a point of sale (POS) transaction system. The POS transaction system includes a smart card, a POS location transaction device, a transaction collection device, and a central processing system. The POS location transaction device includes a smart card transceiver that receives information including card account information and an available balance from the smart card and transmits information regarding the available balance upon completion of a transaction. A processor determines a transaction purchase amount for the transaction and if the available balance is at least equal to the available balance on the smart card. A first data storage device stores financial data regarding the transaction and a first communication device transfers the financial data in a batch manner.

The transaction collection device includes a second communication device and a second storage. The second communication device downloads the financial data from the first communication device onto the second storage device and transmits the financial data from the second storage device.

The central processing system includes a processor identifies an account corresponding to the POS location based on the financial data and transfers funds from a central funds pool to the account using the Federal Automated Clearing House (ACH) Network.

### BRIEF DESCRIPTION OF THE DRAWINGS

These and other features and advantages of the present invention will be better understood by reading the following detailed description, taken together with the drawings wherein:

FIG. 1 is a block diagram of one embodiment of the multi-application payment system according to the present invention; and

FIG. 2 is a flow chart illustrating one embodiment of the multi-application payment method according to the present invention.

### DETAILED DESCRIPTION OF THE PREFERRED EMBODIMENTS

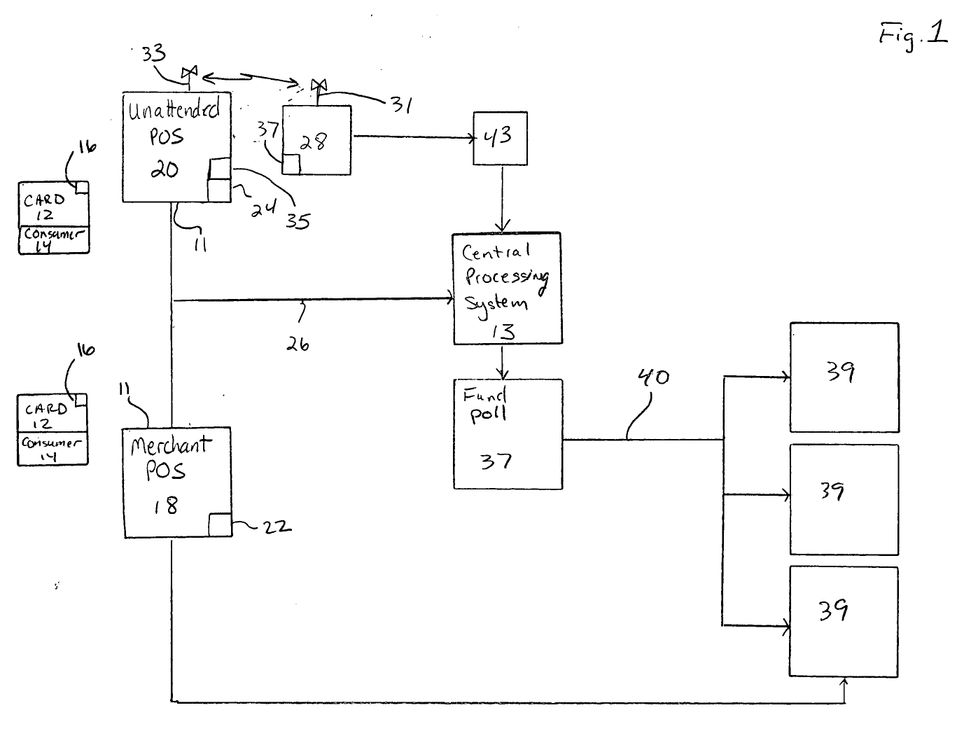

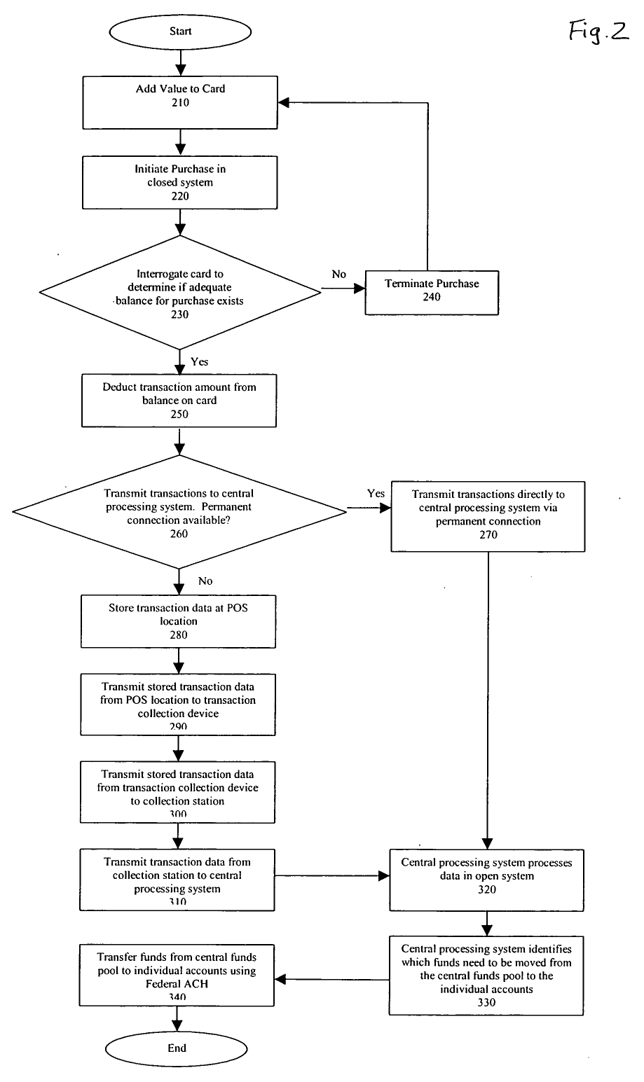

According to one embodiment, the present invention features a multi-application payment system 10, FIG. 1, and method 100, FIG. 2, that operates in a hybrid open/closed manner. While not a limitation of the present invention unless specifically claimed as such, the multi-application payment system 10 is particularly suited for use in the parking industry. As will be discussed in further detail hereinbelow, the multi-application payment system 10 includes a card 12 that is utilized by a consumer 14 to make purchases at point of sale (POS) locations 11 (such as merchant locations 18 or unmanned POS locations 20) wherein the transfer of funds are processed by a central processing system 13 in a hybrid closed/open manner.

The card 12 preferably includes a microprocessor 16 such as, but not limited to, a smart card, that keeps track of the outstanding balance available on the card 12. At least some of the POS locations 11 accept funds from the user 14 and allow the user to load and/or reload funds onto the card 12. The POS location 11 may charge and/or collect additional fees to load/reload funds onto the card 12.

When funds are loaded onto the card 12 or spent at POS locations 11, the card 12 keeps track of the available balance and increments the balance accordingly. This way, the user 14 can verify how much money is remaining on the card 12. It is important to note that the funds can be loaded/reloaded and spent at POS locations 11 that are located anywhere, i.e., funds can be loaded/reloaded and/or spent at different POS locations 11 than where the card 12 was initially obtained. In the preferred embodiment, the cards 12 are initially created without any monetary value. A benefit to initially creating the cards 12 without any monetary value is that the cards can be distributed to the POS locations 11 with minimal risk of theft and/or fraud.

As mentioned, the card 12 is used to purchase goods and/or services at various POS locations 11 without any geographical limitations. As used herein, POS locations 11 include both merchant locations 18 as well as unmanned POS locations 20. The term merchant location 18 is intended to include any location that is directly supervised or attended by a human such as, but not limited to a traditional store, parking garage having a parking agent, and the like. In contrast, the term unmanned POS location 20 is intended to include any location that is not under direct human supervision or that is unattended. Examples of unmanned POS locations 20 include, but are not limited to, unattended parking meters, unattended parking garages, vending machines, and the like. For simplicity, these unmanned POS locations 20 will generally be referred to as meters 20.

The merchant locations 18 preferably include terminal security modules 22. The terminal security modules 22 are preferably securely distributed to the merchant locations 18 with monetary value in order to load/reload the cards 12 use at the merchant locations 18. In contrast, the unattended POS locations 20 preferably include meter security modules 24 that are preferably distributed to meter suppliers (i.e., manufacturers of the maters 20) for installation into the meters 20 without any monetary value. The security modules 22, 24 are preferably identical in their form, but are configured differently. The POS modules 22 are preferably configured to allow loads/reloads and purchases and contain value. The meter modules 24 are preferably configured only to allow purchases and contain no value. Each terminal security module 22, and meter security module 24 is assigned an identifier that corresponds to a particular account holder such as, but not limited to, a city or private parking authority, merchant account, or the like, for audit and management purposes.

In practice, a user 14 obtains a card 12 (preferably by purchasing the card 12) at a POS location 11 as explained above and adds funds to the card 12 (act 210). The user 14 can then purchase goods and/or services at any POS location 11. To initiate the purchase (act 220), the POS location 11 interrogates the card 12 to determine if adequate funds exist for the purchase (act 230). It is important to note that the interaction between the card 12 and the POS locations 11 is performed in a closed manner. If inadequate funds are available on the card 12, the transaction is terminated (act 240) and the user 14 must load additional funds onto the card 12 in order to complete the transaction (act 210). If adequate funds exist on the card 12, then the transaction amount is deducted from card 12 (act 250) and the purchase is completed between the card holder and the POS location 11. It is important to note that this accounting occurs between the card 12 and the POS location 11.

The POS location 11 then uploads or transmits its transactions to the central processing system 13 (act 270). The transaction may be transmitted substantially immediately, but are preferably transmitted periodically in a generally batch type mode. Transmitting the transactions in a batch mode reduces the telecommunications requirements necessary at the POS locations 11 and allows the multi-application payment system 10 to be easily incorporated into a wide variety of POS locations 11. The transactions may be uploaded using a phone line, internet connection, wireless connection, or the like 26. If a permanent connection 26 is available, the transaction data is preferably transmitted directly to the central processing system (act 270).

For applications in which a phone line, internet connection, wireless connection or the like 26 is not practical i.e., a permanent connection 26 is not available, the present invention preferably features a transaction collection device 28. The transaction collection device 28 eliminates the need of the POS location 11 to communicate directly with the central processing system 13. This allows the multi-application payment system 10 according to the present invention to with a wide range of POS locations 11. While not a limitation of the present invention, a transaction collection device 28 is most suited for use with unmanned POS locations 20 such as unattended off-line or on-line parking meters, vending machines, and the like as explained in greater detail hereinbelow.

In many applications, it is not practical to wire a power line and/or a phone/internet line directly to all of the unmanned POS locations 20. As a result, the known unmanned POS locations 20 are often powered by batteries which, of course, have a limited power supply. Moreover, most of the transactions that take place at unmanned POS locations 20 involve large numbers of very small dollar transactions. For illustrative purposes only, transactions at unmanned parking meters, vending machines, and the like typically involve less than $1.00 per transaction. The power requirements necessary to separately communicate (and especially to send wireless signals) for each and every transaction at an unmanned POS location 20 is simply impractical and the cost of building an unmanned POS location 20 device capable of separately communicating every transactions is also impractical. Therefore, the known unmanned POS locations cannot take advantage of the benefits of an open loop transaction system.

As will be explained in greater detail hereinbelow, the transaction collection device 28 and the POS location 11 according to the present invention each preferably feature communication devices 31, 33 (which may include any type of hard connection device or wireless connection device) that allows the transaction collection device 28 to communicate (preferably using encryption) with the POS locations 11 and to download data stored at the POS location 11 regarding all the purchases made at the POS locations 11 in a batch manner, i.e., all the transaction at a POS locations 11 that have taken place over a certain period of time. Because the data is collected from the POS locations 11 in a batch manner, the power requirements for each POS location 11 is substantially reduced, making the multi-application payment system 10 according to the present invention suitable for use with virtually any POS location 11 and particularly suited for use with unmanned POS locations 20. The data downloaded by the transaction collection device 28 is then transmitted to the central processing system 13.

Once a purchase is completed at the POS location 11 (i.e., after the POS location 11 interrogates the card 12 (act 230) and debits the purchase on the card 12 (act 250)), data regarding the transaction is stored on a storage device 35 (such as a flash memory, a hard drive or the like) at the POS location 11 (act 280). This data includes, but is not limited to, financial data such as the purchase price, any additional fees, identification data such as the card 12 identifier as well as the POS location 11 identifier, time/date data, and optionally data regarding the goods/services purchased. Additional purchases at the POS location 11 may also be stored on the storage device 35 at the POS location 11.

Rather than transmitting this data after each and every purchase, the data is stored on the storage device 35 at the POS location 11 (act 280). Because the transaction collection device 28 is mobile, the transaction collection device 28 can be used to periodically communicate with multiple POS locations 11 over a wide area using the communication devices 31, 33 and to download the relevant data from the storage device 35 (such as a hard drive or the like) at the POS location 11 onto a storage device 37 on the transaction collection device 28 (act 290). Once downloaded onto the transaction collection device 28 (act 290), the data may be deleted from the storage device 35 at the POS location 11. Alternatively, the data may remain on the storage device 35 at the POS location and be written over when additional storage space is needed.

For illustrative purposes only, the POS locations 11 may include unattended street parking meters 20. In this scenario, an operator positions the transaction collection device 28 close enough to allow the transaction collection device 28 to download the transactions from the unattended street parking meters 20. Alternatively, the transaction collection device 28 may be integrated into a vehicle which drives up/down the streets and downloads the transactions from the unattended street parking meters 20.

The data stored on the multiple collection devices 28 is preferably downloaded onto a collection station 43 (act 300). Alternatively, the collection devices 28 may transmit the data directly to the central processing system 13. The collection station 43 is preferably connected to the central processing system 13 via the internet (or other communications medium) and uploads the data on a periodic basis (act 310).

From here, the central processing system 13 then processes the data (act 320) and moves the appropriate funds to the correct account. It is important to note that whereas the transaction itself (i.e., the interaction between the card 12 and the POS locations 11) operates in a generally closed manner, the central processing system 13 transfers funds in a generally open manner.

The central processing system 13 identifies which funds need to be moved from the central funds pool 37 to the individual accounts 39 (act 330). The funds are preferably transferred using the Federal Automated Clearing House (ACH) Network 40 (act 340). The funds are settled with each merchant and the city preferably on a net basis. Net inflow of funds causes value to be moved into the funds pool 37 and a new outflow of funds causes it to be removed from the funds pool 37.

As a result, the multi-application payment system and method according to the present invention substantially eliminates the need for customers to carry cash. The multi-application payment system and method also is easily integrated into any POS location, including unmanned or unattended POS locations which have previously been impractical due to power requirements. The multi-application payment system and method also features a card that can be used at any location without any geographical limitations and without modification. Furthermore, the multi-application payment system and method can process the transactions at the POS locations and move the necessary funds in a secure and cost effect manner.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. A multi-application payment method comprising the acts of:
performing a first transaction between a card and a point of sale (POS) location at said POS location in a closed system, said act including:
determining an available balance on said card;
comparing an amount of said first transaction to said available balance, if said available balance is less than said first transaction amount, then terminating said first transaction, if said available balance is at least equal to said first transaction amount, then deducting said first transaction amount from said available balance on said card; and
storing data regarding said first transaction at said POS location;
transmitting said data from said POS location to a central processing system; and
processing said data at said central processing system in an open system.

2. The multi-application payment method as claimed in claim 1 wherein said act of transmitting said data includes transmitting said data in a batch manner.

3. The multi-application payment method as claimed in claim 1 wherein said act of transmitting said data includes periodically transmitting said data.

4. The multi-application payment method as claimed in claim 1 wherein said act of transmitting said data includes collecting said data from said POS location to a data collection device and transmitting said data from said data collection device to said central processing system.

5. The multi-application payment method as claimed in claim 4 further including collecting said data from said POS location to a data collection device using a wireless connection.

6. The multi-application payment method as claimed in claim 1 wherein said act of processing said data at said central processing system in said open system further includes:
identifying an account corresponding to said POS location from said data; and
transferring funds from a central funds pool to said account.

7. The multi-application payment method as claimed in claim 6 wherein said act of transferring funds is performed using the Federal Automated Clearing House (ACH) Network.

8. The multi-application payment method as claimed in claim 1 further including the act of adding value to said card at said POS location.

9. The multi-application payment method as claimed in claim 8 wherein said act of adding value to said card further includes determining a new available balance and storing said new available balance on said card.

10. The multi-application payment method as claimed in claim 9 wherein said act of adding value to said card is performed in a closed system.

11. A multi-application payment method comprising the acts of:
performing a first transaction between a card and a point of sale (POS) location wherein said first transaction is completed between said card and said POS location in a generally closed manner;
transmitting data relevant to said first transaction from said POS location to a central processing system; and
routing funds between a central pool of funds and at least one user account in a generally open loop manner.

12. The multi-application payment method as claimed in claim 11 wherein said act of performing said first transaction includes comparing an amount of said first transaction to an available balance stored on said card, said act of comparing including:
terminating said first transaction if said available balance is less than said first transaction amount; and
deducting said first transaction amount from said available balance on said card and completing said first transaction with respect to said card if said available balance is at least equal to said first transaction amount.

13. The multi-application payment method as claimed in claim 12 wherein said act of transmitting said data includes transmitting said data in a batch manner.

14. The multi-application payment method as claimed in claim 12 wherein said act of transmitting said data includes periodically transmitting said data.

15. The multi-application payment method as claimed in claim 1 wherein said act of transmitting said data includes wirelessly collecting said data from said POS location to a data collection device and transmitting said data from said data collection device to said central processing system.

16. The multi-application payment method as claimed in claim 4 further including collecting said data from said POS location to a data collection device using a wireless connection.

17. The multi-application payment method as claimed in claim 6 wherein said act of routing funds is performed using the Federal Automated Clearing House (ACH) Network.

18. A multi-application payment method comprising:
performing a first transaction between a card and a point of sale (POS) location at said POS location in a closed system, said act including:
receiving data from said card including card account information and an available balance;
comparing an amount of said first transaction to said available balance, if said available balance is less than said first transaction amount, then terminating said first transaction, if said available balance is at least equal to said first transaction amount, then deducting said first transaction amount from said available balance on said card; and
storing financial data regarding said first transaction at said POS location;
transmitting said financial data from said POS location to a transaction collection device in a batch manner;
transmitting said financial data from said transaction collection device to a central processing system; and
processing said financial data at said central processing system in an open system, said act of processing including:
identifying an account corresponding to said POS location from said data; and
transferring funds from a central funds pool to said account using the Federal Automated Clearing House (ACH) Network.

19. A point of sale (POS) transaction system comprising:
a smart card;
a POS location transaction device including:
a smart card transceiver, said smart card transceiver receiving information including card account information and an available balance from said smart card and transmitting information regarding said available balance upon completion of a transaction;
a processor determining a transaction purchase amount for said transaction and determining if said available balance is at least equal to said available balance on said smart card;
a first data storage device storing financial data regarding said transaction; and
a first communication device transferring said financial data in a batch manner;
a transaction collection device including a second communication device and a second storage, wherein said second communication device downloads said financial data from said first communication device and stores said financial data onto said second storage device and transmits said financial data from said second storage device; and
a central processing system including a processor identifying an account corresponding to said POS location based on said financial data and transferring funds from a central funds pool to said account using the Federal Automated Clearing House (ACH) Network.

20. The POS transaction device as claimed in claim 19 wherein said POS location device further includes a parking meter.
